(19) United States
(12) Patent Application Publication
(10) Pub. No.: US 2026/0280789 A1
(43) Pub. Date: Sep. 17, 2026

(54) NR PDCCH SEARCH SPACE CONFIGURATION

(71) Applicant: Telefonaktiebolaget LM Ericsson (publ), Stockholm (SE)

(72) Inventors: Hong Ren, Kanata, Ontario (CA); Björn Nordström, Hässelby (SE); Haomin Li, Kanata, Ontario (CA); Patrick Lie Chin Cheong, Kanata, Ontario (CA); Aaron Callard, Kanata, Ontario (CA)

(21) Appl. No.: 19/472,906

(22) PCT Filed: Apr. 5, 2023
(86) PCT No.: PCT/IB2023/053490

§ 371 Date: Oct. 6, 2025

(51) Int. Cl. H04L 5/00

(52) U.S. Cl. CPC H04L 5/0044; H04L 5/0007

(57) ABSTRACT

Various embodiments disclosed herein provide for a method and apparatus to configure different User Specific Search spaces (USSs) for Physical Downlink Control Channel (PDCCH) candidates for different User Equipment devices (UEs). By selecting different USS configurations for different UEs, the search spaces can cover fewer symbols that there can be more PDCCH candidates in each symbol. By configuring each UE with a selected USS, the PDCCH capacity can be improved by optimizing Control Channel Element (CCE) utilization and improving downlink capacity by increasing the number of symbols used for Physical Downlink Shared Channel (PDSCH) use.

### TECHNICAL FIELD

The present disclosure relates to configuring User Equipment devices (UEs) with UE specific Search Spaces (USSs) for Physical Downlink Control Channel (PDCCH) in a wireless communications system.

### BACKGROUND

Next Radio (NR) is the fifth-generation cellular technology this is being deployed worldwide. The NR Physical Downlink Control Channel (PDCCH) is used to carry scheduling information such as Downlink Control Information (DCI). One or multiple Orthogonal Frequency Division Multiplexing (OFDM) symbols can be used for NR PDCCH. If one symbol is used, 72 Resource Elements (REs) in the symbol are grouped to form a Control Channel Element (CCE). Depending on the link quality of a user and the message size of the DCI, different numbers of CCEs may be used and/or needed to transmit the DCI. According to 3GPP (the 3^{rd} Generation Partnership Project) specifications, only a limited number of CCEs are allowed. They are 1, 2, 4, 8 and 16. These numbers of CCEs are referred to as aggregation levels (ALS)

When a user equipment device (UE) tries to decode a DCI for itself, it performs blind decoding over a number of candidates. A candidate defines the specific CCEs for a given AL. For a given UE, when its search spaces are configured, the number of candidates for each aggregation level is configured. A search space can be a common search space (CSS) or UE-specific search space (USS).

Usually, only one OFDM symbol is configured for NR PDCCH when NR is first deployed. As the NR users increases, the single symbol PDCCH can become a bottleneck. That is, the PDCCH can't carry DCI for enough number of users. As a result, the traffic channel resource can't be fully utilized.

One of the solutions is to use multiple OFDM symbols for NR PDCCH. According to 3GPP specifications, there are following limitations for search space configuration:
Max number of monitored PDCCH candidates per slot and per serving cell is 44 for sub-carrier spacing of 15 KHz.
Max number of non-overlapping CCEs per slot for a downlink bandwidth part of a serving cell is 56 for sub-carrier spacing of 15 KHz.

When multiple OFDM symbols are used for NR PDCCH, it is better that the actual number of symbols used to be able to change from slot to slot, based on the PDCCH load. By doing so, PDCCH only uses the resources that are required to transmit the DCI, and the other symbols can be used for physical downlink shared channel (PDSCH) to send user traffic. For this purpose, when a UE specific search space is configured, it is better that the search space doesn't use the max number of PDCCH symbols. Conventionally, multiple UE specific search spaces (one per OFDM symbol) can be configured so that the UE's PDCCH can be put on any symbol.

In one example, with a bandwidth of 40 MHz and sub-carrier spacing of 15 kHz, one OFDM symbol has 36 CCEs. Assuming common search space uses 4 PDCCH candidates and 8 non-overlapping CCEs, there can be 40 candidates and 48 non overlapping CCEs left for UE specific search space. Given DCIs to schedule UE specific PDSCH (DCI 1-1) have different size than that to schedule UE specific physical uplink shared channel (PUSCH) (DCI 0-1), there are only 20 PDCCH candidates for DCI 1-1 or DCI 0-1 when the candidates are divided evenly.

Conventionally, to support multiple (for example 3) PDCCH symbols is to configure 3 search spaces for each UE with each search space covering one symbol. If there is only one UE, its PDCCH can be allocated in symbol 0 and all other symbols can be used to carry user traffic. If there are many UEs to be scheduled, up to 3 symbols can be used for PDCCH. Considering the limitation on the number of PDCCH candidates and the number of non-overlapping CCEs, the three UE-specific search spaces can be configured in the following way:
USS #1 on symbol 0 (32 non-overlapping CCEs):
   1 candidate for AL of 16;
   1 candidate for AL of 8;
   1 candidate for AL of 4;
   1 candidate for AL of 2; and
   2 candidates for AL of 1.
USS #2 on symbol 1 (8 non-overlapping CCEs):
   1 candidate for AL of 4;
   1 candidate for AL of 2; and
   2 candidates for AL of 1.
USS #3 on symbol 2 (8 non-overlapping CCEs):
   1 candidate for AL of 4;
   1 candidate for AL of 2; and
   2 candidates for AL of 1.

The PDCCH search space configuration described above ensure that there are PDCCH candidates in each symbol. The same configuration can be used for all UEs for a simple solution.

The simple solution described above can lead to the following issues. The CCEs in symbol 0 may not be fully utilized due to the small number of candidates. Additionally, the CCEs in symbol 1 and 2 may not be fully utilized due to a small number of candidates, and there are no candidates for AL of 8 and/or 16. Another problem can be that AL of 8 and 16 are only supported in symbol 0. If a PDCCH with AL of 8 or 16 cannot be allocated in symbol 0, the PDCCH has to be dropped.

### SUMMARY

Various embodiments disclosed herein provide for a method and apparatus to configure different user specific search spaces (USSs) for Physical Downlink Control Channel (PDCCH) candidates for different User Equipment devices (UEs). For a given UE, the search spaces can cover fewer symbols so that there can be more PDCCH candidates in each symbol. In addition, different USSs configured for the same UE may have different number of PDCCH candidates even all USSs have the same number of Control Channel Elements (CCEs). Finally, the UE-specific search spaces configured for a UE with more PDCCH candidates may occupy different CCEs than the UE-specific search spaces configured for a different UE with more PDCCH candidates.

Some of the advantages provided by the methodology disclosed herein is that the PDCCH capacity can be improved by optimizing CCE utilization and improving downlink capacity by increasing the number of symbols used for Physical Downlink Shared Channel (PDSCH) use.

In an embodiment, a method performed by a base station for configuring UEs with USSs can include selecting a USS configuration for a UE from two or more sets of USS configurations where each set of USS configurations from the two or more sets of USS configurations has one or more respective sets of PDCCH candidates, and the one or more respective sets of PDCCH candidates for different sets of USS configurations are distributed differently across N Orthogonal Frequency Division Multiplexing (OFDM) symbols within a slot. The method can also include sending, to the UE, information that configures the UE with the selected USS configuration.

In an embodiment, different USS configurations are selected for different UEs in a same cell.

In another embodiment, selecting the USS configuration for the UE includes selecting the USS configuration for the UE from the two or more sets of USS configurations based on a PDCCH load of an associated cell.

In another embodiment, selecting the USS configuration for the UE includes selecting at least one set of USS configurations from the two or more sets of USS configurations, based on a PDCCH load of an associated cell and selecting the USS configuration for the UE from the at least one set of USS configurations.

In another embodiment, selecting at least one set of USS configurations includes selecting, based on the PDCCH load, one of a plurality of target UE distributions across the two or more sets of USS configurations and selecting the at least one set of USS configurations from the two or more sets of USS configurations in accordance with the one of the plurality of target UE distributions selected based on the PDCCH load.

In another embodiment, each of the plurality of target UE distributions defines a target distribution of UEs across one or more of the two or more sets of USS configurations.

In another embodiment, for each of a plurality of slots, the method includes estimating a PDCCH load for the slot, determining, based on the PDCCH load for the slot, likelihood values for each possible number of OFDM symbols used for PDCCH in the slot, wherein the possible numbers of OFMD symbols used for PDCCH in the slot are 1, . . . , N. The method also includes receiving, in a particular slot from among the plurality of slots, a connection request from the UE where selecting the USS configuration for the UE and sending the information that configures the UE with the selected USS configuration are performed responsive to receiving the connection request from the UE.

In an embodiment, the method includes selecting at least one set of USS configurations from the two or more sets of USS configurations, based on the likelihood values for a preceding slot and selecting the USS configuration for the UE from the at least one set of USS configurations.

In another embodiment, selecting at least one set of USS configurations includes selecting, based on the likelihood values for the preceding slot, one of a plurality of target UE distributions across the two or more sets of USS configurations and selecting the at least one set of USS configurations from the two or more sets of USS configurations in accordance with the one of the plurality of target UE distributions.

In another embodiment, each of the plurality of target UE distributions defines a target distribution of UEs across one or more of the two or more sets of USS configurations.

In an embodiment, the plurality of target distributions include a first target distribution where configurations are selected from a first set of configurations, a second target distribution where configurations are selected from the first set of configurations and a second set of configurations, and a third target distribution where configurations are selected from the first set of configurations, the second set of configurations, and a third set of configurations.

In an embodiment, the third target distribution is applied in response to a first likelihood value associated with three symbols is equal to or above a first threshold.

In an embodiment, the second target distribution is applied in response to a second likelihood value associated with two symbols is equal to or above a second threshold.

In an embodiment, the first target distribution is applied in response to the third target distribution and the second target distribution not being applied.

In an embodiment, the method includes configuring each bandwidth part, BWP, of the UE 112 with different USS configurations.

In an embodiment, a base station configured to configuring UEs with USSs can include a radio interface and processing circuitry configured to select a USS configuration for a UE from two or more sets of USS configurations where each set of USS configurations from the two or more sets of USS configurations has one or more respective sets of PDCCH candidates, and the one or more respective sets of PDCCH candidates for different sets of USS configurations are distributed differently across N OFDM symbols within a slot. The processing circuitry can also send, to the UE, information that configures the UE with the selected USS configuration.

In an embodiment, a non-transitory computer-readable medium comprising instructions stored thereon, that when implemented by a processor can perform operations for configuring UEs with USSs, the operations including selecting a USS configuration for a UE from two or more sets of USS configurations where each set of USS configurations from the two or more sets of USS configurations has one or more respective sets of PDCCH candidates, and the one or more respective sets of PDCCH candidates for different sets of USS configurations are distributed differently across N OFDM symbols within a slot. The operations can also include sending, to the UE, information that configures the UE with the selected USS configuration.

In an embodiment, a method performed by a base station for configuring UEs with USSs can include selecting a USS configuration for a UE where one or more USSs configured for a UE may occupy a portion of the CCEs occupied by UE-specific search spaces configured for a plurality of UEs in a cell, and the one or more USS configured for the UE can have a first number of PDCCH candidates and another USS configured for the UE can have a second number of PDCCH candidates, wherein the USS and the other USS are associated with a same number of CCEs, and a first USS with a highest number of PDCCH candidates of the one more USSs associated with the UE is associated with different CCEs than a second USS with a highest number of PDCCH candidates of one or more USSs associated with another UE. The method can also include sending, to the UE, information that configures the UE with the selected USS configuration.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system according to some embodiments of the present disclosure;

FIG. 2 illustrates a table of sets of User Equipment device (UE) specific search spaces (USSs) for 10/15 MHz bandwidths according to some embodiments of the present disclosure;

FIG. 3 illustrates a table of sets of UE specific search spaces (USSs) for 20 MHz bandwidths according to some embodiments of the present disclosure;

FIG. 4 illustrates a table of sets of USSs for 25 MHz bandwidths according to some embodiments of the present disclosure;

FIG. 5 illustrates a table of sets of USSs for 30 MHz bandwidths according to some embodiments of the present disclosure;

FIG. 6 illustrates a table of sets of USSs for 40 MHz bandwidths according to some embodiments of the present disclosure;

FIG. 7 illustrates a table of sets of USSs for 50 MHz bandwidths according to some embodiments of the present disclosure;

FIG. 8 is a flowchart of a method performed by a base station for configuring UEs with USSs according to some embodiments of the present disclosure;

FIG. 9 is a schematic block diagram of a radio access node according to some embodiments of the present disclosure;

FIG. 10 is a schematic block diagram that illustrates a virtualized embodiment of the radio access node of FIG. 9 according to some embodiments of the present disclosure; and

FIG. 11 is a schematic block diagram of the radio access node of FIG. 9 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Note that the description given herein focuses on a Third Generation Partnership Project (3GPP) cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to Fifth Generation (5G) New Radio (NR) concepts, beams may be used instead of cells and, as such, it is important to note that the concepts described herein are equally applicable to both cells and beams.

Various embodiments disclosed herein provide for a method and apparatus to configure different user specific search spaces (USSs) for Physical Downlink Control Channel (PDCCH) candidates for different User Equipment devices (UEs) based on current estimated PDCCH load. The USS configurations can be selected from a predefined sets of configurations for respective bandwidths wherein respective sets are each optimized for different PDCCH estimated loads.

Some of the advantages provided by the methodology disclosed herein is that by selecting different USS configurations for different UEs, the search spaces can cover fewer symbols that there can be more PDCCH candidates in each symbol. By configuring each UE with a selected USS, the PDCCH capacity can be improved by optimizing control channel element (CCE) utilization and improving downlink capacity by increasing the number of symbols used for Physical Downlink Shared Channel (PDSCH) use.

Instead of trying to configure UE-specific search spaces to cover all possible symbols to be used for PDCCH, the search spaces configured for a given UE covers less symbols so that some search space can have more PDCCH candidates. In addition, different USSs configured for the same UE may have different number of PDCCH candidates even all USSs have the same number of CCEs. Finally, the UE-specific search spaces configured for a UE with more PDCCH candidates may occupy different CCEs than the UE-specific search spaces configured for a different UE with more PDCCH candidates. The search space configuration for a newly connected UE is based on the latest estimated PDCCH load.

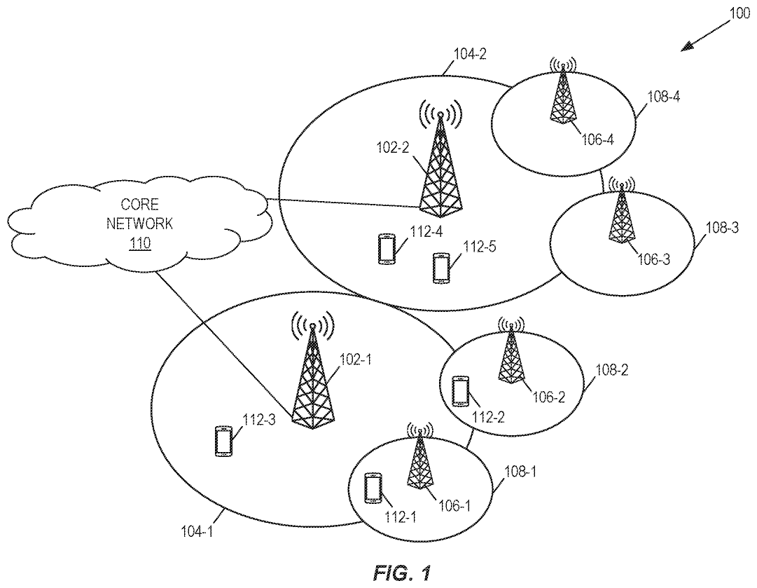

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC) In this example, the RAN includes base stations 102-1 and 102-2, which in the 5GS include NR base stations (gNBs) and optionally next generation eNBs (ng-eNBs), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to UEs 112-1 through 112-5 in the corresponding cells 104 and 108. The UEs 112-1 through 112-5 are generally referred to herein collectively as UEs 112 and individually as UEs 112. The base station 102 can provide USS configurations to the UEs 112 by configuring the UEs 112 with a selected USS configuration based on the PDCCH load of the cell 104 or 108. The USS configuration can direct the UEs 112 to search for PDCCH candidates in a more limited search space which can optimize the (e.g., reduce) the amount of space needed to transmit downlink control information (DCI), thus freeing up space for PDSCH use. The UEs 112 can be configured with USS configurations when the UEs 112 connect to the base station 102 where the USS configuration is based on the bandwidth and the current PDCCH load at the time of the connection (or just prior thereto). Overtime, as UEs 112 connect and disconnect to the base station 102, as the PDCCH load varies, the configuration distribution is adjusted slowly. Although the actual configuration can be different from the target distribution most of the time, it is expected that improved performance will be achieved.

According to the present disclosure different USSs can be configured for different UEs. A cell has multiple USS configurations. For example, if we want to support up to 3 PDCCH symbols, a cell can have three sets of configurations as below:
Set1: the USS configurations in this set includes configuration for one or more USSs for a UE and the USS occupying symbol 0 can have most PDCCH candidates.
Set2: the USS configurations in this set includes configuration for one or more USSs for a UE and the USS occupying symbol 1 have most PDCCH candidates.
Set3: the USS configurations in this set includes configuration for one or more USSs for a UE and the USS occupying symbol 2 have most PDCCH candidates.

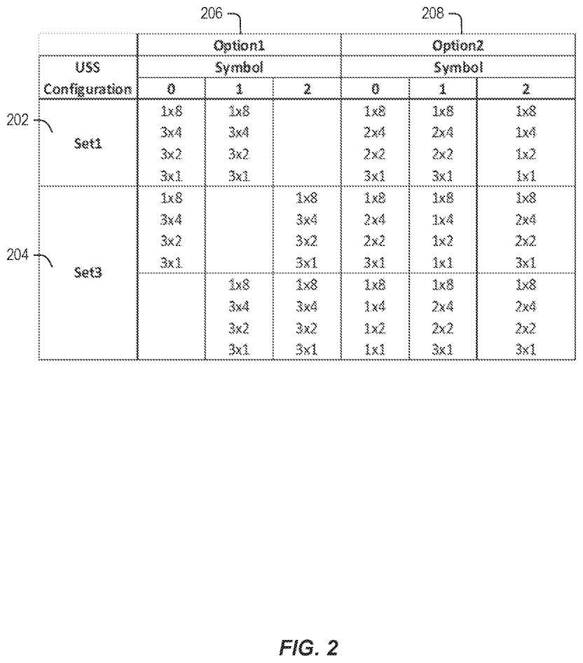

FIG. 2 illustrates a table of sets of USS configurations for 10/15 MHz bandwidths according to some embodiments of the present disclosure. In the table in

FIG. 2, there can be two different sets-Set1 202 and Set3 204. In this particular example for a bandwidth of 10/15 MHz, the Set2 can be identical to Set1 202 and is therefore not shown separately. For each of the sets, there can be one or more options for configurations (e.g., option 1 206 and option 2 208) that provide different distributions of PDCCH candidates search spaces.

In FIG. 2, two options for USS configuration are shown with the assumptions that the total number of USS candidates is limited to 40 and the total number of non-overlapping CCEs for USS is limited to 48. The configurations for DCI 0-1 and DCI 1-1 are the same so they each get 20 candidates.

With option1 206, set1 202 has one configuration in which same number of candidates (10) are configured for symbol 0 and symbol 1. In FIG. 2, 1×8 means 1 candidate for an aggregation level (AL) of 8 and 3×4 means 3 candidates for AL of 4 CCEs, and so on. Set2 is the same as set1 202. Set3 204 has two configurations: one for symbol 0 and symbol 2 while the other for symbol 1 and symbol 2.

With option2 208, set1 202 has one configuration which covers all 3 symbols. There are more candidates in symbols 0 and 1 compared to that in symbol 2. Set2 is the same as set1. Set3 204 again has two configurations: one with more candidates in symbol 0 and symbol 2 while the other with more candidates in symbol 1 and symbol 2.

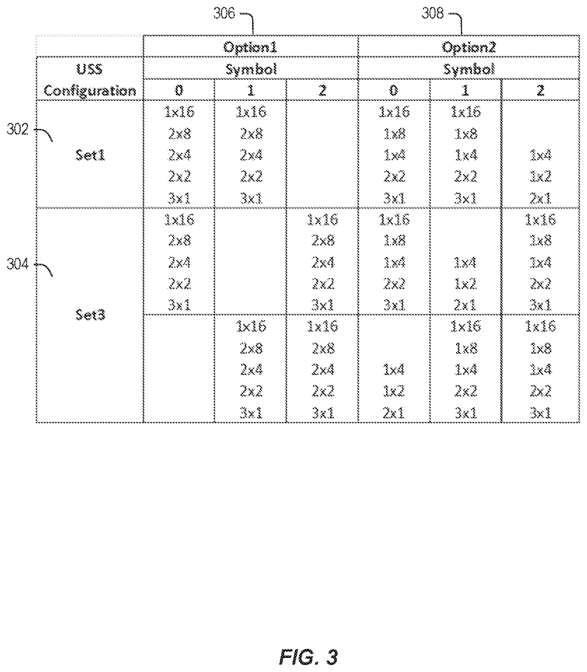

FIG. 3 illustrates a table of sets of USS configurations for 20 MHz bandwidths according to some embodiments of the present disclosure. In the table in FIG. 3, there are two sets, Set1 302 and Set3 304 (Set2 is identical to Set1 as in FIG. 2), and two different options for each of the sets, Option1 306 and Option2 308.

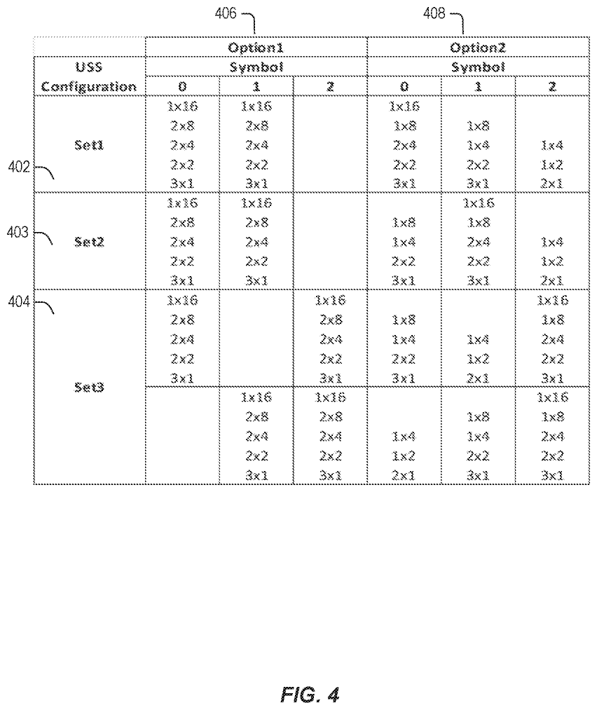

FIG. 4 illustrates a table of sets of USS configurations for 25 MHz bandwidths according to some embodiments of the present disclosure. In the table in FIG. 4, there are three sets, Set1 402, Set2 403 and Set3 404, and two different options for each of the sets, Option1 406 and Option2 408.

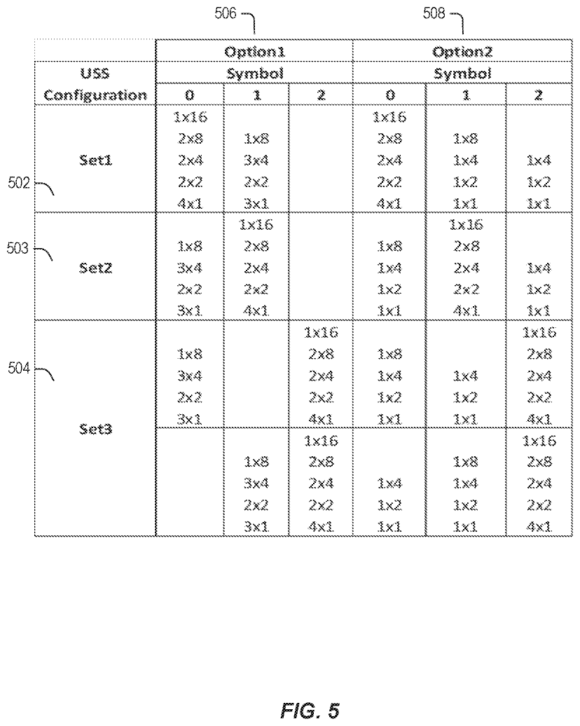

FIG. 5 illustrates a table of sets of USS configurations for 30 MHz bandwidths according to some embodiments of the present disclosure. In the table in FIG. 5, there are three sets, Set1 502, Set2 503 and Set3 504, and two different options for each of the sets, Option1 506 and Option2 508.

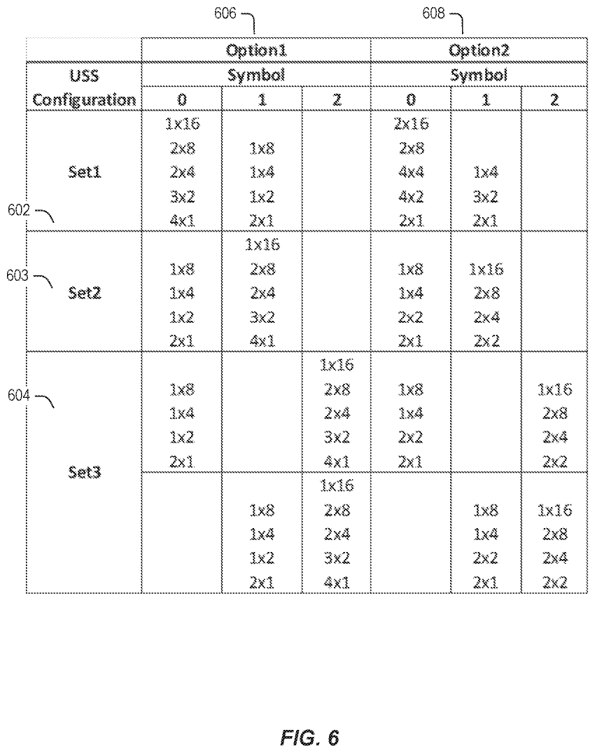

FIG. 6 illustrates a table of sets of USS configurations for 40 MHz bandwidths according to some embodiments of the present disclosure. In the table in FIG. 6, there are three sets, Set1 602, Set2 603 and Set3 604, and two different options for each of the sets, Option1 606 and Option2 608.

With 40 MHz (36 CCEs with sub-carrier spacing of 15 kHz), there is no candidates for AL1 in some symbol for some configurations for option2. For a UE 112 with excellent link quality, an AL of 1 may be good enough. In this case, a PDCCH can be assigned with an AL of 2 for the UE 112 if the PDCCH resource is available. With so many CCEs in a symbol, using a few extra CCEs will not have a detrimental effect.

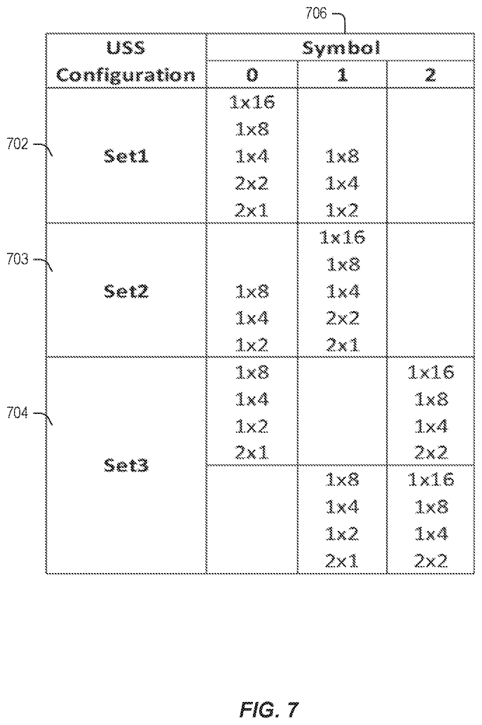

FIG. 7 illustrates a table of sets of USS configurations for 50 MHz bandwidths according to some embodiments of the present disclosure. In the table in FIG. 7, there are three sets, Set1 702, Set2 703 and Set3 704, but only a single option 706 for the three sets.

With 50 MHz (45 CCEs with sub-carrier spacing of 15 kHz), there are no candidates for AL1 in symbol 2 for configurations in set3. For a UE with excellent link quality, an AL of 1 may be good enough. In this case, a PDCCH can be assigned with an AL of 2 for the UE if the PDCCH resource is available. With so many CCEs in a symbol, using a few extra CCEs would not have a detrimental effect.

When radio resource control (RRC) connection is set up for a UE, one USS configuration from one of the three sets is selected for the UE based on the latest estimated PDCCH load.

The PDCCH load can be estimated in many ways. One estimation method is described below.

In each slot, all UEs with data to send or receive are listed in the order of priority (from high to low).

For each UE, the number of required resource blocks (RBs) to empty the UE's buffer is estimated based on the link quality and the amount of data in the buffer. A predefined or configured bandwidth margin in terms of the number of RBs is added to the bandwidth to get the inflated bandwidth. Given the inflated bandwidth, if there are RBs to carry the UE's data, the UE is identified as one that are likely to be scheduled in the slot.

For each UE identified above, estimate the aggregation level for its PDCCH. Then, estimate the number of PDCCH symbols needed to schedule all identified UEs assuming there are unlimited number of candidates in each symbol for each UE. Please note the true bandwidth is used when estimating the number of PDCCH symbols needed to schedule all identified UEs.

The reason for the assumption of unlimited number of candidates is to simplify the estimation. However, the assumption would normally lead to under-estimation of the number of CCEs required. To compensate for the error introduced by the assumption, an inflated bandwidth is used so that more UEs may be identified as ones that are likely to be scheduled in a slot.

After the actual PDCCH allocation, the actual number of PDCCH in this slot can be known. The PDCCH load in terms of the number of required PDCCH symbol in slot n can be defined as:

$$L ( n ) = Min ( 3 , Max ( estimated number of PDCCH symbols , actual number of PDCCH symbols ) )$$

For all possible number of symbols s (s=1, 2 and 3 for up to 3 PDCCH symbols):

```
If s = = L(n)
  Prob(s, n) = 1
Else
  Prob(s, n) = 0
End
  Likelihood(s, n) = forgetting factor * prob(s, n) + (1 − forgetting
  factor) * Likelihood(s, n)
End
```

This likelihood value can be the result of the Recursive Least Squares Filter algorithm as shown in the equation above. The likelihood value indicates the likelihood that a s number of symbols will be required for a slot n.

Based on this likelihood value for a slot, the USS configuration performed by the base station 102 is as follows.

Three target USS configuration distributions can be provided, where the USS configuration distributions support up to 3 PDCCH symbols. The target USS configuration distributions are the ones that can achieve high PDCCH capacity while using less PDCCH symbols. They can be obtained based on simulations or live network testing. Below are some examples.

The target USS configuration distribution #1 is one with all UEs being configured with configurations from set1. With this target distribution, all UEs have more candidates in symbol 0 so that symbol 0 can be highly utilized.

The target USS configuration distribution #2 is one where 65% of UEs are configured with configurations from set1 and 35% of UEs are configured with configurations from set2.

With the target USS configuration distribution #2, most UEs have more PDCCH candidates in symbol 0 so that it can be highly utilized. At the same time, some UEs have more candidates in symbol 1. In case that 2 (or even 3) PDCCH symbols are needed, some UE's PDCCH can be put on symbol 1.

With target USS configuration distribution #3, 45% of UEs being configured with configurations from set1, 30% of UEs being configured with configurations from set2, 25% of UEs being configured with configurations from set3.

With the target USS configuration distribution #3, a large percentage of UEs have more PDCCH candidates in symbol 0 so that it can be highly utilized. At the same time, some UEs have more candidates in symbol 1 and a smaller percentage of UEs have more candidates in symbol 2. In case that 2 or 3 PDCCH symbols are needed, there would be enough UEs whose PDCCH can be put on symbol 1 and/or 2.

Initially, the base station 102 can configure all UEs with configurations from set1, but then as the PDCCH load increases, the base station 102 can start to configure UEs with USSs according to target distribution #2, and then as the PDCCH load increases further, from target distribution #3.

In each slot, PDCCH load is estimated and likelihood values of symbols in each slot for all possible number of symbols is updated, and then when a new RRC connection is setup (e.g., a new UE connecting to the base station 102) in slot n, check the latest likelihood values for the immediately preceding slot n-1.

Condition 1: If the likelihood value for 3 symbols in slot n-1 is equal to or greater than a first threshold, target distribution #3 is applied, where a USS configuration from Set1, or set2 or set3 is selected to achieve the above target. If the selected set includes multiple UE-level USS configurations, one UE-level USS configuration in the set is then selected. When a USS configuration set contains multiple UE-level USS configurations, each UE-level USS configuration may be assigned with a weight. The selection of the UE-level USS configuration from the set is based on the assigned weight. For example, when a USS configuration set contains two UE-level USS configurations, the two UE-level USS configurations may be assigned with weights of 0.6 and 0.4, respectively. In this case, the UE-level USS configuration with a weight of 0.6 will be selected with a probability of 60% while the other is selected with a probability of 40%.

Condition 2: If condition 1 is not met, but if the likelihood value for 2 symbols in slot n−1 is equal to or greater than a second threshold, target distribution #2 is applied by the base station 102 and the UE is assigned a USS configuration from either Set1 or Set2.

If neither Condition 1 nor Condition 2 are met, then target distribution #1 is applied by the base station 102 and the base station 102 assigns the newly connected UE a USS configuration from Set1.

For the algorithm above, only the USS configuration for newly connected UEs is affected. When PDCCH load varies, the configuration distribution is adjusted slowly. Although the actual configuration can be different from the target distribution most of the time, it is expected that good performance can still be achieved.

If the USS configuration distribution is very different from the target distribution, some UE's USS can be re-configured using RRC messages. Of course, using RRC messages to re-configure USS leads to extra signaling load. It also takes quite some time to make the configuration change.

Another approach is to configure multiple bandwidth parts (BWPs). Those BWPs have the same bandwidth and location in frequency domain, but they have different USS configurations. For example, two BWPs can be configured for a UE: one is associated with a USS configuration in set1 while the other is associated with a USS configuration in set2. In this case, changing USS configuration can be achieved by BWP switching.

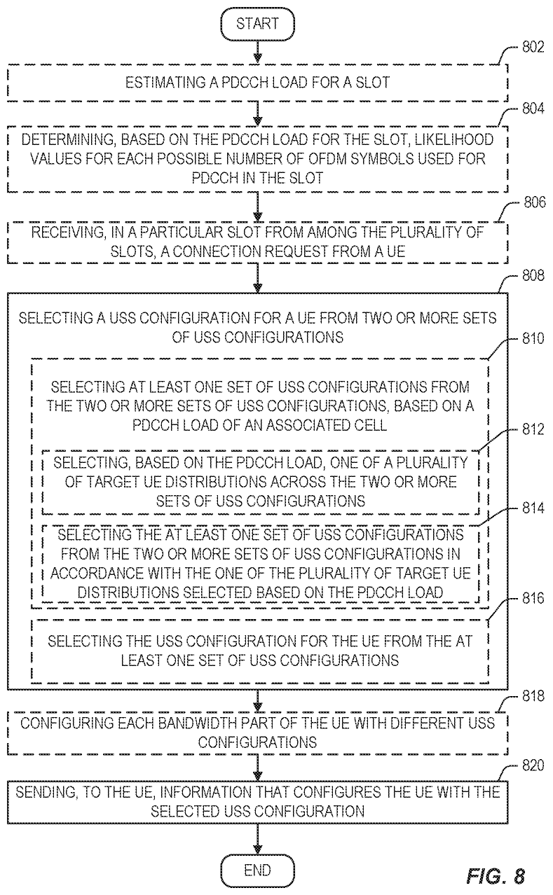

FIG. 8 is a flowchart of a method performed by the base station 102 for configuring UEs (e.g., UE 112) with USSs according to some embodiments of the present disclosure. It is to be appreciated that steps of the method that are in dashed boxes are optional steps. It is also to be appreciated that the order of the steps of the method is exemplary, and that in some embodiments, the steps of the method can be performed in a different order.

In an embodiment, the method can begin at step 802 where a PDCCH load is estimated for a slot. The PDCCH load can be estimated based on a determined PDCCH load for one or more previous slots. For example, the PDCCH load can be based on the immediately preceding slot, or based on some function of PDCCH loads of a predetermined number of slots. As described above, one of the techniques in which the load can be estimated is determining for each slot, all the UEs with data to send or receive are listed in the order of priority (from high to low) and then for each UE, the number of required resource blocks (RBs) to empty the UE's buffer is estimated based on the link quality and the amount of data in the buffer. A predefined or configured bandwidth margin in terms of the number of RBs is added to the bandwidth to get the inflated bandwidth. Given the inflated bandwidth, if there are RBs to carry the UE's data, the UE is identified as one that are likely to be scheduled in the slot.

For each UE identified above, estimate the aggregation level for its PDCCH. Then, estimate the number of PDCCH symbols needed to schedule all identified UEs assuming there are unlimited number of candidates in each symbol for each UE.

After the actual PDCCH allocation, the actual number of PDCCH in this slot can be known. The PDCCH load in terms of the number of required PDCCH symbol in slot n can be defined as:

$$L ( n ) = Min ( 3 , Max ( estimated number of PDCCH symbols , actual number of PDCCH symbols ) )$$

At step 804, the method can include determining, based on the PDCCH load for the slot, likelihood values for each possible number of OFDM symbols used for PDCCH in the slot, wherein the possible numbers of OFDM symbols used for PDCCH in the slot are 1, . . . , N.

At step 806, the method can include receiving, in a particular slot from among the plurality of slots, a connection request from the UE.

At step 808, the method includes selecting a USS configuration for a UE from two or more sets of USS configurations. In an embodiment, the selecting of the USS configuration can be in response to receiving the connection request from the UE. In an embodiment, different UEs in the cell can be configured with different USS configurations. Furthermore, for a given UE with multiple USSs, some of the USSs may have more PDCCH candidates than others. Additionally, even though different USSs may have same number of CCE, they could have a different number of PDCCH candidates.

In an embodiment, each set of USS configurations from the two or more sets of USS configurations has one or more respective sets of PDCCH candidates. Additionally, the one or more respective sets of PDCCH candidates for different sets of USS configurations can be distributed differently across N OFDM symbols within a slot. The PDCCH resources of a cell can be viewed as the sum of the resources configured for common search space and UE-specific search space for all UEs. In an embodiment, multiple USSs can be configured for a UE. One USS configured for a UE occupies a fraction of the PDCCH resources of the cell. The multiple USS configured for a UE may or may not overlap.

In an embodiment, one or more USSs configured for a UE may occupy a portion of the CCEs occupied by UE-specific search spaces configured for a plurality of UEs in a cell. Furthermore, the one or more USS configured for the UE can have a first number of PDCCH candidates and another USS configured for the UE can have a second number of PDCCH candidates, wherein the USS and the other USS are associated with a same number of CCEs. Additionally, a first USS with a highest number of PDCCH candidates of the one more USSs associated with the UE is associated with different CCEs than a second USS with a highest number of PDCCH candidates of one or more USSs associated with another UE.

In an embodiment, the selecting the USS configuration for the UE can also include selecting, at step 810, at least one set of USS configurations from the two or more sets of USS configurations, based on a PDCCH load of an associated cell and selecting, at step 816, the USS configuration for the UE from the at least one set of USS configurations when the selected set has multiple UE-level USS configurations.

In an embodiment, the selecting step at 810 can also include selecting, at step 812, based on the PDCCH load, one of a plurality of target UE distributions across the two or more sets of USS configurations and selecting, at step 814 the at least one set of USS configurations from the two or more sets of USS configurations in accordance with the one of the plurality of target UE distributions selected based on the PDCCH load.

The method can also include configuring, at step 818, each BWP of the UE with different USS configurations.

At step 820, the method can include sending, to the UE, information that configures the UE with the selected USS configuration.

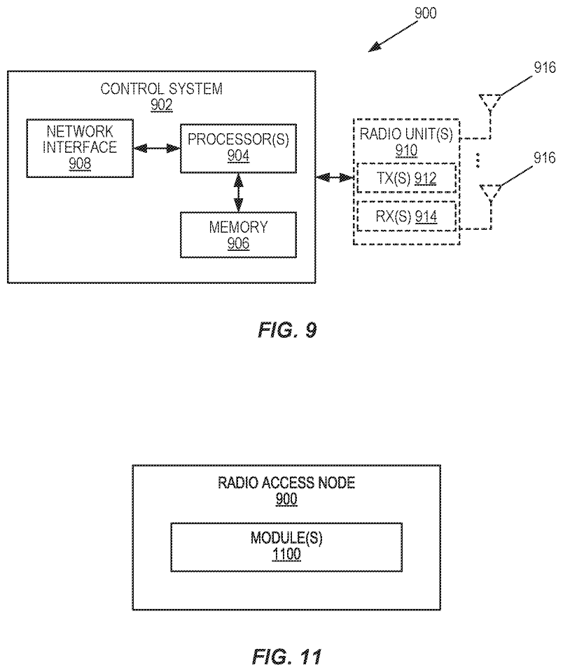

FIG. 9 is a schematic block diagram of a radio access node 900 according to some embodiments of the present disclosure. Optional features are represented by dashed boxes. The radio access node 900 may be, for example, a base station 102 or 106 or a network node that implements all or part of the functionality of the base station 102 or gNB described herein. As illustrated, the radio access node 900 includes a control system 902 that includes one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. In addition, the radio access node 900 may include one or more radio units 910 that each includes one or more transmitters 912 and one or more receivers 914 coupled to one or more antennas 916. The radio units 910 may be referred to or be part of radio interface circuitry. In some embodiments, the radio unit(s) 910 is external to the control system 902 and connected to the control system 902 via, e.g., a wired connection (e.g., an optical cable). However, in some other embodiments, the radio unit(s) 910 and potentially the antenna(s) 916 are integrated together with the control system 902. The one or more processors 904 operate to provide one or more functions of a radio access node 900 as described herein. In some embodiments, the function(s) are implemented in software that is stored, e.g., in the memory 906 and executed by the one or more processors 904.

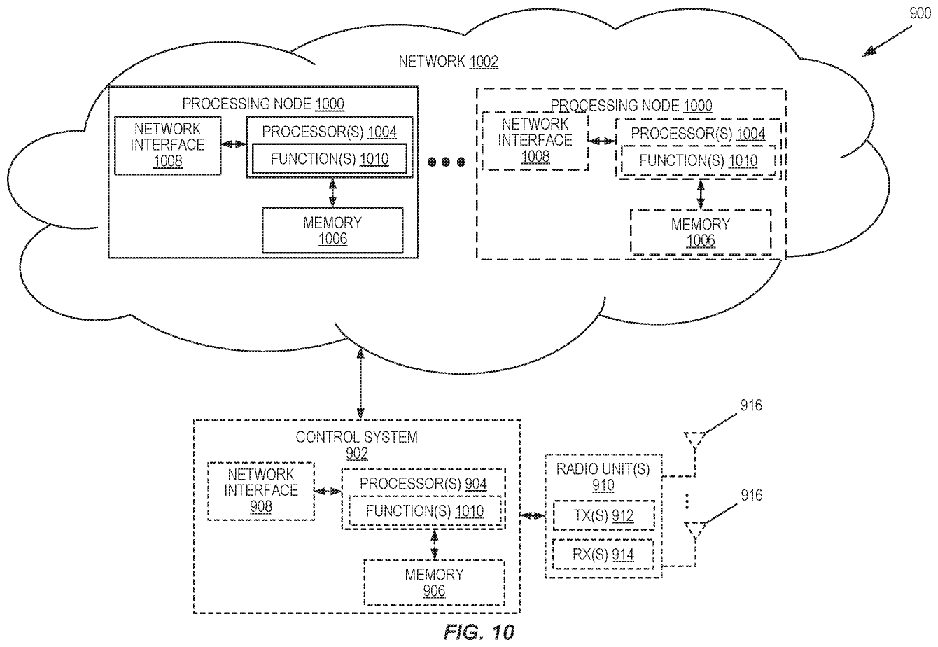

FIG. 10 is a schematic block diagram that illustrates a virtualized embodiment of the radio access node 900 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 900 in which at least a portion of the functionality of the radio access node 900 is implemented as a virtual component(s) (e.g., via a virtual machine(s) executing on a physical processing node(s) in a network(s)). As illustrated, in this example, the radio access node 900 may include the control system 902 and/or the one or more radio units 910, as described above. The control system 902 may be connected to the radio unit(s) 910 via, for example, an optical cable or the like. The radio access node 900 includes one or more processing nodes 1000 coupled to or included as part of a network(s) 1002. If present, the control system 902 or the radio unit(s) are connected to the processing node(s) 1000 via the network 1002. Each processing node 1000 includes one or more processors 1004 (e.g., CPUs, ASICS, FPGAS, and/or the like), memory 1006, and a network interface 1008.

In this example, functions 1010 of the radio access node 900 described herein are implemented at the one or more processing nodes 1000 or distributed across the one or more processing nodes 1000 and the control system 902 and/or the radio unit(s) 910 in any desired manner. In some particular embodiments, some or all of the functions 1010 of the radio access node 900 described herein are implemented as virtual components executed by one or more virtual machines implemented in a virtual environment(s) hosted by the processing node(s) 1000. As will be appreciated by one of ordinary skill in the art, additional signaling or communication between the processing node(s) 1000 and the control system 902 is used in order to carry out at least some of the desired functions 1010. Notably, in some embodiments, the control system 902 may not be included, in which case the radio unit(s) 910 communicate directly with the processing node(s) 1000 via an appropriate network interface(s).

In some embodiments, a computer program including instructions which, when executed by at least one processor, causes the at least one processor to carry out the functionality of radio access node 900 or a node (e.g., a processing node 1000) implementing one or more of the functions 1010 of the radio access node 900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the radio access node 900 according to some other embodiments of the present disclosure. The radio access node 900 includes one or more modules 1100, each of which is implemented in software. The module(s) 1100 provide the functionality of the radio access node 900 described herein. This discussion is equally applicable to the processing node 1000 of FIG. 10 where the modules 1100 may be implemented at one of the processing nodes 1000 or distributed across multiple processing nodes 1000 and/or distributed across the processing node(s) 1000 and the control system 902.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a base station for configuring User Equipments (UEs) with UE-specific Search Spaces (USSs), the method comprising:
selecting a USS configuration for a UE from two or more sets of USS configurations, wherein:
each set of USS configurations from the two or more sets of USS configurations has one or more respective sets of Physical Downlink Control Channel (PDCCH) candidates; and
the one or more respective sets of PDCCH candidates for different sets of USS configurations are distributed differently across N Orthogonal Frequency Division Multiplexing (OFDM) symbols within a slot; and
sending, to the UE, information that configures the UE with the selected USS configuration;
wherein selecting the USS configuration for the UE comprises:
selecting at least one set of USS configurations from the two or more sets of USS configurations, based on a PDCCH load of an associated cell; and
selecting the USS configuration for the UE from the at least one set of USS configurations based on a set of assigned weights for the USS configurations.

2. The method of claim 1, wherein different USS configurations are selected for different UEs in a same cell.

3. The method of claim 1, wherein selecting the USS configuration for the UE comprises selecting the USS configuration for the UE from the two or more sets of USS configurations based on a PDCCH load of an associated cell.

4. (canceled)

5. The method of claim 4, wherein selecting at least one set of USS configurations comprises:
selecting, based on the PDCCH load, one of a plurality of target UE distributions across the two or more sets of USS configurations; and
selecting the at least one set of USS configurations from the two or more sets of USS configurations in accordance with the one of the plurality of target UE distributions selected based on the PDCCH load.

6. The method of claim 5, wherein each of the plurality of target UE distributions defines a target distribution of UEs across one or more of the two or more sets of USS configurations.

7. The method of claim 1, further comprising:
for each of a plurality of slots:
estimating a PDCCH load for the slot; and
determining, based on the PDCCH load for the slot, likelihood values for each possible number of OFDM symbols used for PDCCH in the slot, wherein the possible numbers of OFMD symbols used for PDCCH in the slot are 1, . . . , N; and
receiving, in a particular slot from among the plurality of slots, a connection request from the UE;
wherein selecting the USS configuration for the UE and sending the information that configures the UE with the selected USS configuration are performed responsive to receiving the connection request from the UE.

8. The method of claim 7, wherein selecting the USS configuration for the UE comprises:
selecting at least one set of USS configurations from the two or more sets of USS configurations, based on the likelihood values for a preceding slot; and
selecting the USS configuration for the UE from the at least one set of USS configurations.

9. The method of claim 8, wherein selecting at least one set of USS configurations comprises:
selecting, based on the likelihood values for the preceding slot, one of a plurality of target UE distributions across the two or more sets of USS configurations; and
selecting the at least one set of USS configurations from the two or more sets of USS configurations in accordance with the one of the plurality of target UE distributions.

10. The method of claim 9, wherein each of the plurality of target UE distributions defines a target distribution of UEs across one or more of the two or more sets of USS configurations.

11. The method of claim 9, wherein the plurality of target distributions comprise:
a first target distribution where configurations are selected from a first set of configurations;
a second target distribution where configurations are selected from the first set of configurations and a second set of configurations; and
a third target distribution where configurations are selected from the first set of configurations, the second set of configurations, and a third set of configurations.

12. The method of claim 11, wherein the third target distribution is applied in response to a first likelihood value associated with three symbols is equal to or above a first threshold.

13. The method of claim 11, wherein the second target distribution is applied in response to a second likelihood value associated with two symbols is equal to or above a second threshold.

14. The method of claim 11, wherein the first target distribution is applied in response to the third target distribution and the second target distribution not being applied.

15. The method of claim 11, further comprising:
configuring each bandwidth part (BWP) of the UE with different USS configurations.

16. A base station configured to configuring User Equipments (UEs) with UE-specific Search Spaces (USSs), the base station comprising a radio interface and processing circuitry configured to:
select a USS configuration for a UE from two or more sets of USS configurations, wherein:
each set of USS configurations from the two or more sets of USS configurations has one or more respective sets of Physical Downlink Control Channel (PDCCH) candidates; and
the one or more respective sets of PDCCH candidates for different sets of USS configurations are distributed differently across N Orthogonal Frequency Division Multiplexing (OFDM) symbols within a slot; and
send, to the UE, information that configures the UE with the selected USS configuration;
wherein the processing circuitry is further configured to:
select at least one set of USS configurations from the two or more sets of USS configurations, based on a PDCCH load of an associated cell; and
select the USS configuration for the UE from the at least one set of USS configurations based on a set of assigned weights for the USS configurations.

17-30. (canceled)

31. A non-transitory computer-readable medium comprising instructions stored thereon, that when implemented by a processor perform operations for configuring User Equipments (UEs) with UE-specific Search Spaces (USSs), the operations comprising:
selecting a USS configuration for a UE from two or more sets of USS configurations, wherein:
each set of USS configurations from the two or more sets of USS configurations has one or more respective sets of Physical Downlink Control Channel (PDCCH) candidates; and
the one or more respective sets of PDCCH candidates for different sets of USS configurations are distributed differently across N Orthogonal Frequency Division Multiplexing (OFDM) symbols within a slot; and
sending, to the UE, information that configures the UE with the selected USS configuration.

32. A method performed by a base station for configuring User Equipments (UEs) with UE-specific Search Spaces (USSs), the method comprising:
selecting a USS configuration for a UE, wherein:
one or more USSs configured for a UE may occupy a portion of the Control Channel Elements (CCEs), occupied by UE-specific search spaces configured for a plurality of UEs in a cell;
the one or more USS configured for the UE can have a first number of Physical Downlink Control Channel (PDCCH) candidates and another USS configured for the UE can have a second number of PDCCH candidates, wherein the USS and the other USS are associated with a same number of CCEs; and
a first USS with a highest number of PDCCH candidates of the one or more USSs configured for the UE is associated with different CCEs than a second USS with a highest number of PDCCH candidates of one or more USSs configured for another UE; and
sending, to the UE, information that configures the UE with the selected USS configuration.
